(19) United States
(12) Patent Application Publication
(10) Pub. No.: US 2023/0241427 A1
(43) Pub. Date: Aug. 3, 2023

(54) IMPROVED FILTERING MASK

(71) Applicant: U-EARTH BIOTECH LTD, London (GB)

(72) Inventor: Elisabetta MAGGIO, London (GB)

(21) Appl. No.: 17/910,771

(22) PCT Filed: Mar. 16, 2021
(86) PCT No.: PCT/IB2021/052183

§ 371 Date: Sep. 9, 2022

(30) Foreign Application Priority Data
Mar. 16, 2020 (IT) 102020000005515

(51) Int. Cl. A62B 23/02; A41D 13/11; B01D 39/16; B32B 5/02; B32B 7/05

(52) U.S. Cl. CPC A62B 23/025; A41D 13/11; B01D 39/1623; B32B 5/022; B32B 7/05; B01D 2239/0442; B01D 2239/0435; B01D 2239/0618; B01D 2239/0627; B01D 2239/065; B32B 2250/20; B32B 2260/021; B32B 2260/04; B32B 2262/0253; B32B 2307/20; B32B 2307/724; B32B 2571/00

(57) ABSTRACT

The present invention relates to personal protective equipment, specifically to a filtering device for the protection of the respiratory tract, which can be worn on the face of a user. In particular, the present invention relates to a wearable filtering mask comprising said filtering device (filtering means) for the protection of the respiratory tract and, furthermore, it relates to said filtering device (filtering means), preferably in the form of multilayer filtering means. Lastly, the present invention relates to a face mask that can be worn and configured to filter air.

### TECHNICAL FIELD OF THE INVENTION

The present invention relates to personal protective equipment, specifically to a filtering device for the protection of the respiratory tract, which can be worn on the face of a user. In particular, the present invention relates to a wearable filtering mask comprising said filtering device (filtering means) for the protection of the respiratory tract and, furthermore, it relates to said filtering device (filtering means), preferably in the form of multilayer filtering means. Lastly, the present invention relates to a face mask that can be worn and configured to filter air.

### BACKGROUND

As known, numerous solutions relating to filtering masks are available on the market. The user wearing one of such devices is protected from airborne contaminants that are harmful if inhaled (for example particles, PM 10 or PM 2.5 particles, pollen, vapours and gases) thanks to an air filtering element. Such devices can cover the face completely or even only a portion of the face, for example mouth and nose. In particular filtering face masks are devices that are applied to the head of the user and adhere to the face covering the nose, mouth and sometimes chin. In some cases, filtering face masks may be disposable (such as for example surgical masks which are medical devices—MD (outlet filtering) and not personal protective equipment—PPE (inlet and inlet filtering)). In other cases, the masks are provided with replaceable valves and/or filters, in any case equipped with components selected as a function of the type of filtering efficiency desired.

However, known devices reveal some significant drawbacks.

For example, although the surgical mask ensures an effective shielding for those surrounding the user wearing it, it represents a very poor inlet barrier for volatile substances given that it typically does not adhere perfectly to the face and still leaves fissures through which they can be inhaled. Furthermore, surgical masks are not very effective against thinner suspension substances, for example in the form of aerosols, which can still pass through the filtering element.

Disadvantageously, most known devices must be disposed even if they are only temporarily removed from the face, with obvious disadvantages in terms of cost-effectiveness and sustainability. The aforementioned devices also have a temporally limited filtering efficiency, often in the order of a few hours, forcing the user to replace them frequently.

With regard to face masks provided with a valve, such valve is inserted to compensate for a high respiratory resistance, as in the case of masks recommended for the protection against pathogens FFP2/N95 or FFP3/N99, facilitating the outflow which is unfiltered. Should there arise the need to reduce spread and cross-contamination, this is not desirable given that the potential carrier of the disease through the outlet valve would pose a risk to others.

Furthermore, known face masks, particularly reusable ones, are often subject to proliferation of bacteria and viruses due to the heat and humidity of breath, especially in the case of prolonged use.

Document WO 2012/130117 A1 relates to a structure (face mask) for reducing the transmission of human pathogens. The structure comprises one or more hydrophilic outer layers and one or more hydrophilic inner layers active against pathogens that are isolated inside the structure. The structure includes an acid or a mixture of acids to create a low pH environment so that droplets containing pathogens are absorbed inside and outside the structure. Among all the acids listed, in a long list, usnic acid is also mentioned.

Document KR 102 026 892 B1 discloses a face mask for covering the nose and mouth of the user, comprising a removable cartridge-shaped filter. Rings for attachment to the ears of a user in such a mask are integrally connected with a surface of the mask.

Document EP 3 398 657 A1 discloses a mask comprising a body, portions for attaching to the ears and filtering parts. The body may be made of silicone or plastic. Preferably, the side parts of the body may be obtained by means of nano-injection and they are provided with elasticity.

Document WO 2016/069898 A1 discloses materials configured to transport and release a variety of active compounds by means of coated or non-coated and uncoated yarns and other substrates. Example 2 illustrates that usnic acid is a naturally-derived compound (from lichens) which acts as an active analgesic, antiviral agent, antimitotic agent and anti-inflammatory, and it was used for the apparent activity thereof in helping people lose weight. This active ingredient, obtained as a fine powder, was suspended at a concentration of 2% by weight (20 mg/gm) in a sample of Novagard 200-260 RTV silicone polymer. The suspension of the usnic acid in Novagard 200-260 was then soaked in and/or on the 30-weight cotton thread (mercerised, 100% cotton), passing the cotton through the usnic-in-RTV suspension over a length of about 10 inches.

The scientific article (Review Article) entitled “Face Masks in the New COVID-19 Normal: Materials, Testing, and Perspectives” relates to filtering masks and protective systems.

### SUMMARY OF THE INVENTION

The technical problem posed and solved by the present invention is therefore that of providing a face mask that allows to overcome one or more of the aforementioned drawbacks with reference to the prior art. In particular, the technical problem lies in providing a face mask, preferably a wearable filtering mask, comprising a filtering device to protect the respiratory tract (filtering device, preferably in the form of a multilayer filtering device) capable of offering improved shielding of the nose and mouth of the user wearing it, increased filtering capacity/efficiency and that has high sustainability, both with reference to materials used, such as recycled materials, for the preparation of at least one part of the face mask (such as the cover) with reference to the duration of use thereof and, thus, the possibility of disposing of a part of the face mask, for example the filtering device only.

Such problem is solved by a face mask according to claim 1, by means of the filtering means according to claim 10, and by means of a face mask configured to filter the air according to claim 28.

Preferred characteristics of the present invention are subject of the dependent claims.

In the present context, the expression “face mask” is synonymous with “filtering mask” and it is to be understood in its broadest sense to include any personal protective equipment, which can be worn on the face of a user or health worker, in the form of a mask or half-mask, it is specifically configured to protect upper airways, such as nose and mouth, by filtering inhaled air (for example inhaled and exhaled air with nose and/or mouth).

“Filtering device” is synonymous with “filtering means” “multilayer filtering means” or “refill”.

The filtering of the mask of the invention is intended to prevent the inhalation of contaminants, in the form of powders, mists, fumes, gases or vapours, and of the substances transported therewith.

Preferably, the filtering mask subject of the invention is a mask according to the UNI EN 14683:2019 standard.

Said standard, just like the other standards mentioned in this description, are to be understood in the version of validity at the priority date of the present patent application, unless otherwise specified.

The mask of the invention comprises a front portion, shaped so as to adhere to the face covering the mouth and nose of the user in the mask-worn condition, and means for retaining said front portion to the head of the user. The front portion for example may also be referred to as “cover”.

Advantageously, the means for retaining said front portion (or cover) are made in a manner such to improve the adhesion of said front portion to the face of the user so as to fully cover the face (nose, mouth and chin) and protect the user from the entry of airborne contaminants that are harmful if inhaled (for example particles, PM 10 or PM 2.5 particles, pollen, vapours and gases). A full adhesion of the front portion to the face of the user contributes, together with the filtering means, toward providing an improved filtration.

The mask is provided with filtering means, in particular said filtering means are carried by the front portion and they comprise a bioactive component including usnic acid, preferably usnic acid or a salt thereof, or a complex or compound thereof, or mixtures thereof, more preferably fixed—using natural compatibilizing agents—to a non-woven fabric (in short, “NWF”) by means of a specific finishing process. Preferably, said NWF is obtained with a spunbond (spun-bonded) technique.

The expression “spunbond” is used to indicate an operation for melting the polymer that the NWF consists of, followed by drilling and pressing operations.

The spunbond technique allows to improve the softness of the NWF, and the possibility to make it thinner with respect to NWF produced using other techniques.

The finishing process is applied to the layer referred to as Biolayer or Bio-Layer.

The NWF filtering the air to be breathed (Biolayer) was treated using an aqueous formulation comprising:
beta cyclodextrins and usnic acid, or a salt thereof, dextrorotatory D(+), preferably as a usnic acid sodium salt D(+), for example at 90% by weight, and
demineralized water, for example 10% by weight (Biolayer Liquid Mix).

The filtering NWF layer was processed by means of an impregnation and drying process (finishing treatment).

The aqueous formulation (Biolayer Liquid Mix) contains no dispersant, no glycol, no organic or inorganic solvents, no phthalates, no silicones, no latex, no BHT, no PVC, no heavy metals such as for example silver, copper, titanium ions or salts of these ions, such as titanium oxide, because they are harmful to health.

The filtering NWF made of PP used for the Biolayer was treated with said aqueous formulation and tested with ISO 22196:2007.

The layer referred to as Biolayer of the device subject of the present invention is manufactured with a 100% polyester Non-Woven Fabric (NWF), for example weighing 80 gr/m² untreated (+/−10%), obtained using a spunbond technique.

A finishing treatment is applied to the NWF by carrying out several processing operations with the aim of improving the characteristics thereof for abating the particulate matter/virus/bacteria present in the air which is filtered by the mask.

The entire process (finishing treatment) is reported by way of summary:

(i) the untreated NWF is passed through an impregnation bath consisting of a solution at 90% of and 10% of water (the Biolayer liquid Mix “preparation”), previously mixed prior to being sent to the impregnation machine. During this “wet” operation, the NWF is impregnated with said “preparation” equal to 180/190 gr/m² (net of the weight of the NWF);

(ii) the aforementioned NWF is then subjected to a subsequent processing operation of “squeezing”, “drying” and rewinding into rolls.

All the aforementioned operations ensure the deposit of an amount of “preparation” at least equal to 50 g/m² (net of the weight of the NWF).

The finishing process is a treatment aimed at improving the characteristics of abatement of particulate matter, viruses and/or bacteria present in the air filtered by the mask.

The finishing process preferably comprises the following steps:
impregnation of untreated NWF (i.e. unprocessed, unrefined) with an impregnation solution at 90% of Biolayer Liquid Mix and 10% of water to obtain a impregnated NWF; preferably, the impregnated NWF is impregnated with impregnation solution in an amount comprised from 150 g/m² to 250 g/m², preferably comprised from 170 g/m² to 220 g/m², even more preferably comprised from 180 g/m² to 190 g/m² (net of the specific weight of untreated NWF);
squeezing and drying the impregnated NWF to obtain a dried NWF; preferably, the dried NWF contains a residual amount of impregnation solution comprised from 40 g/m² to 150 g/m², preferably comprised from 50 g/m² to 100 g/m² (net of the specific weight of the untreated NWF);
optionally winding the NWF into a roll or reel.

The Biolayer Liquid Mix comprises usnic acid and/or a salt thereof, preferably usnic acid D(+) and/or a salt thereof, preferably of natural origin and/or a salt thereof; more preferably of natural and non-synthetic origin.

In a preferred embodiment, said Biolayer Liquid Mix comprises a complex or compound selected from usnic acid and/or a salt thereof and a cyclodextrin; preferably β-cyclodextrin, preferably in a 1:1 by weight ratio.

The aqueous formulation (Biolayer Liquid Mix) was also independently tested to verify the antibacterial (with Gram-positive and Gram-negative bacteria) and antiviral capacity. The formulation was tested on a surface as follows:
Dimensions: 50×50 mm;
Shape: rectangular plastic medium coated with square-shaped material to be tested;
Coating film: Square-shaped polyethylene, 40×40 mm, thickness 0.1 mm;
Bacterial strains: Escherichia Coli ATCC 8739 (6×105 cells/ml); Staphylococcus Aureus ATCC 6538P (1×106 cells/ml).

Time t0, t24 (24 hours)

Inoculum volume: 0.4 ml

Neutralizer volume (SCDLP): 20 ml

A non-cytotoxic antiviral efficacy of 0.03%, and efficacy comprised from 92% to 98% was observed.

The presence of usnic acid, preferably usnic acid or a salt thereof, or a complex or compound thereof, or mixtures thereof, significantly reduces the possibility of proliferation of bacteria and viruses in the mask, preventing the growth and spread of typically problematic microorganisms such as clostridia and antibiotic-resistant bacteria—both Gram positive and Gram negative—such as for example MRSA, TBC, VRE and NDM-1.

Advantageously, the filtering means comprise a plurality of superimposed layers and are joined together to form a single replaceable element. The mask is therefore provided with a disposable component that can be used for a range from 150 hours to 200 hours of actual use, referred to as “Refill”, which is beneficial to the durability, sustainability and ease of use thereof.

It will be observed that the device therefore comprises an antiproliferative and bactericidal element with the dual purpose of protecting against viruses and bacteria without using too many layers of filtering material which increase respiratory resistance, and making the device reusable without the user being exposed to the risk of proliferation between one use and another if it is reused.

In a variant embodiment, at least one layer of said plurality is made of non-woven fabric (NWF) made of water-repellent polypropylene, offering a barrier function to protect the bioactive component and so as to preserve the properties thereof over time. Advantageously, the mask of the invention therefore ensures greater durability, simultaneously with a higher filtering efficiency, with respect to known devices.

Preferably, the filtering means comprise a succession of consecutive layers in which each layer has different filtering properties. In this manner, the mask is conferred high versatility of use given that a wide range of substances and/or particles, in terms of shape, nature (solid, liquid or aeriform) and dimensions, can be retained by the filtering means.

Advantageously, the means for retaining the mask are made of a breathable, elastically deformable fabric. Besides allowing to ensure the adhesion and sealing of the mask to the face, the mask is ergonomic and it can be manufactured in a cost-effective manner.

In an embodiment, the retaining means and/or the front portion are made of polyamide or polyamide and a polyurethane synthetic fibre to confer elasticity, for example Spandex, Lycra, or elastane (elastic polyurethane).

Preferably, polyamide from 60% to 90%, preferably from 70% to 80%, and elastane from 10% to 40%, preferably from 20% to 30% by weight, with respect to the total weight, can be used for making the retaining means and/or the front portion. For example, a fabric made of polyamide 78% and elastane 22% by weight, having a weight of about 190 g/m² (height of piece 150 cm) and a weight of about 285 g/linear meter (length of piece 70 metres); dynamometer elongation+/−15%; manual elongation+/−15%, height 90% and length 150% may be used. For example, recycled multifilament polyamide—Elastane (Lycra® Xtra Life™) may be used.

In a preferred embodiment, the retaining means and/or the front portion are made of a waterproof (splash test) fabric comprising polyamide or polyamide and a synthetic polyurethane fibre.

Advantageously, the waterproof treatment applied to the fabric to obtain the retaining means and/or the front portion of the face mask does not alter the dimensional and filtering performance of the fabric. The waterproof treatment is selected from those available on the market, for example www.mitispa.com.

Other advantages, characteristics and methods of use of the present invention will be apparent from the following detailed description of some embodiments, provided by way of non-limiting example.

### BRIEF DESCRIPTION OF THE FIGURES

Reference will be made to the figures of the attached drawings, wherein:

FIG. 1 shows an assembly view of a preferred embodiment of the face mask according to the present invention in a worn-condition on the face of a user;

FIG. 2 shows an exploded view of the face mask illustrated in FIG. 1;

FIGS. 3A and 3B respectively show a front view and a plan schematic view of the filtering means according to a preferred embodiment of the invention; in particular, the difference between FIG. 3A and FIG. 3B lies in the fact that FIG. 3B shows the filtering means in a two-dimensional (stretched) configuration, while FIG. 3A shows the filtering means in a three-dimensional configuration;

FIGS. 4A and 4B respectively show a front view and a plan schematic view of the means for retaining the mask according to a preferred embodiment of the invention; in particular, the difference between FIG. 4A and FIG. 4B lies in the fact that FIG. 4B shows the front portion and the retaining means in a two-dimensional (stretched) configuration of the front portion, while FIG. 4A shows the front portion in a three-dimensional configuration;

FIG. 5 is a micrograph taken through a scanning electron microscope showing a flaking of a cell membrane—thread-like structure in such figure—of a microorganism (E. Coli) following contact with the active ingredient (solid white part adjacent to the fibre).

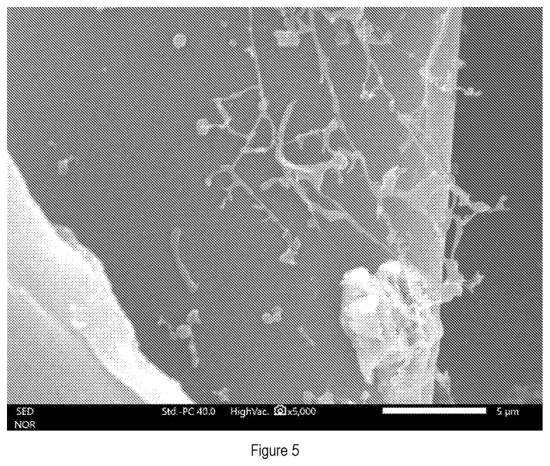

### DETAILED DESCRIPTION OF PREFERRED EMBODIMENTS

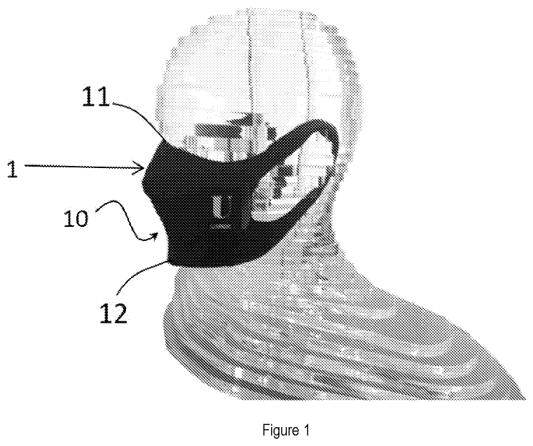

With initial reference to FIG. 1, a face mask according to a preferred embodiment of the invention is indicated in its entirety with 1. In the present example, the mask 1—or device—is in the form of a half-mask and is shaped to adhere to the face of the user or health worker wearing it.

Preferably, the face mask subject of the invention is a flexible duckbill mask.

Preferably, the face mask subject of the invention is characterised by a bacterial filtration efficiency (BFE)—measured according to the UNI EN 14683:2019 standard—comprised from 90% to 100%, preferably comprised from 95% to 99.9%, for example 96%, 97%, 98% or 99%.

Bacterial filtration efficiency is a measurement of the resistance of a material (or of an assembly of layers of material) to the penetration of bacteria. Said measurement is expressed as a percentage of productivity, and is related to the capacity of the material (or of the plurality of layers) to resist against bacterial penetration. High numbers in tests according to the UNI EN 14683:2019 standard indicate a better barrier efficiency.

Analysing the UNI EN 14683:2019 standard in detail, the BFE is determined according to Appendix B of said standard. Preferably, said BFE is tested under the following experimental conditions:
size of the sample: 170 mm×130 mm;
size of the tested area: 49 cm²;
flow velocity (flow rate) during tests: 28.3 l/min.

More preferably, said BFE is comprised in said ranges in both the through-flow directions of said mask (both in inhalation and in exhalation). In other words, both sides of the specimens provided the same results in the present test, irrespective of the side facing toward the test aerosol. The test aerosol is a Staphylococcus aureus bacterial aerosol with an average size of 3.0 μm. The equipment used is a Andersen six-stage cascade impactor.

The mask 1 preferably has a Type I, Type II or Type IIR classification according to the UNI EN 14683:2019 standard, more preferably of Type II or of Type IIR, even more preferably of Type IIR (where letter “R” indicates a splash resistance).

Preferably, the mask subject of the invention is characterised by particle filtration efficiency (PFE)—measured according to the ASTM F2299 standard—comprised from 90% a 100%, preferably comprised from 95% to 100%, for example 95%, 96%, 97% or 98%.

With respect to the protocol specified in the ASTM F2299 standard, the Applicant conducted two series of tests, using PSL particles measuring 3.0 μm and particles measuring 0.1 μm.

Below are some details on the BFE and PFE tests conducted on the face mask of the present invention. The bacterial filtration efficiency (BFE) test measures the percentage of Staphylococcus aureus bacterial aerosol with an average size of 3.0 μm, filtered by the mask. The BFE test according to the EN14683:2019 standard is conducted by placing a face mask specimen on the Andersen 6-stage cascade impactor.

The BFE fitted to face masks can be carried out either in exhalation (outflow) or in inhalation (inflow). The EN14683:2019 standard requires the mask to be tested in exhalation only and to have a minimum BFE threshold equal to 95%. The BFE in exhalation on the face mask of the present invention (batch 10) shows a filtration efficiency higher than 99.65%.

Advantageously, although the face mask of the present invention can be classified—according to the EN14683:2019 standard—as a class I medical device, it offers reversible protection, inflow and outflow. Inhalation BFE tests were carried out to corroborate such argument. The results of the BFE tests on batch 10 show filtration performance higher than 99.62%.

Upon further evaluation of the filtering capacity of the mask, a particle filtration efficiency (PFE) test was carried out with PSL particles measuring 3.0 μm as a variation of the American ASTM F2299 standard. Furthermore, a particle filtration efficiency (PFE) test was carried out with PSL particles measuring 0.1 μm according to the American ASTM F2299 standard. This test is required by the ASTM 2100-20 and FDA US regulation for the evaluation of medical face masks. The test results show PFE filtration efficiency higher than 96%.

Although the EN14683:2019 standard requires outflow BFE test only, the following was also evaluated: 1) inflow BFE, 2) PFE at 3.0 μm according to the ASTM F2299 standard and 3) PFE at 0.1 μm according to the ASTM F2299 standard.

Both the BFE inflow and outflow tests and the PFE test at 0.1 μm according to the ASTM F2299 standard were carried out, regarding batch 10, with fabrics already electrically charged and Spunbond in polypropylene 30 g with closed cells instead of Spunbond in polypropylene 15 g. All these tests showed acceptable positive results.

Preferably, the face mask subject of the invention is characterised by having passed the following tests too:
breathability test determined according to Appendix C of the UNI EN 14683:2019 standard;
microbial cleanliness test determined according to Appendix D of the UNI EN 14683:2019 standard.

Generally, the device 1 (FIG. 1) comprises a front portion 10 (cover) which has a sealing edge designed to adhere to the face so that said front portion 10, in the device 1 worn condition, can cover at least the mucous membranes of the nose and mouth. The expression “device worn” is to be understood in the condition in which the mask is put on according to the right size.

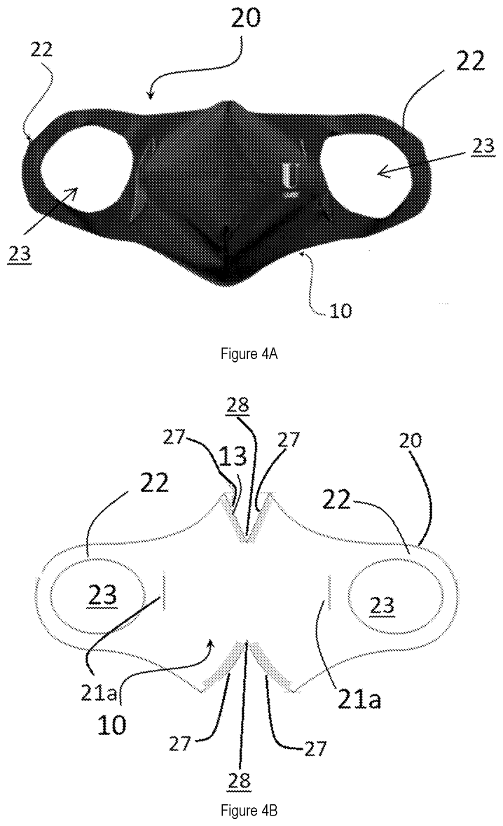

In the illustrated example, the front portion 10 comprises an upper sealing edge 11 and a lower sealing edge 12 which extend respectively to cover the face, from the nasal saddle to the chin and part of the jaw. The retaining means 20 of the front portion 10 secure the mask to the face and, as observable in the example illustrated in FIGS. 4A and 4B, comprise flaps 22 protruding from opposite sides of the front portion 10. Said flaps 22 are shaped so as to be constrained to the ears of the user, in particular with an eyelet 23. More precisely, the flaps 22 are closed in a ring with the front portion 10, so as to circumscribe a pair of eyelets 23.

In unworn conditions, the front portion 10 has an overall dimension preferably equivalent to a substantially equilateral surface of about 15 cm (centimetres) on the side and the device 1, considered as a whole with the retaining means 20, has a lateral overall dimension preferably comprised between 30 and 35 cm (centimetres).

Obviously, the shapes, dimensions and covering surface of the device 1 may vary with respect to those of the illustrated example (for example, depending on different measurements, sizes or models) which, advantageously, has small overall dimension and allows to easily supplement auxiliary articles wearable by the user, such as for example eyeglasses, hoods and the like.

In a variant embodiment, the device 1 may be provided or associated with a flexible element to be positioned on the nasal saddle, for a better adherence of the mask thereto. By way of example, said flexible element is an elastic element or a metal rod.

Similarly, the retaining means 20 may provide for different embodiments with respect to the ones mentioned above; for example, they may be made in the form of laces or elastic bands to be passed behind the ears or tied behind the nape.

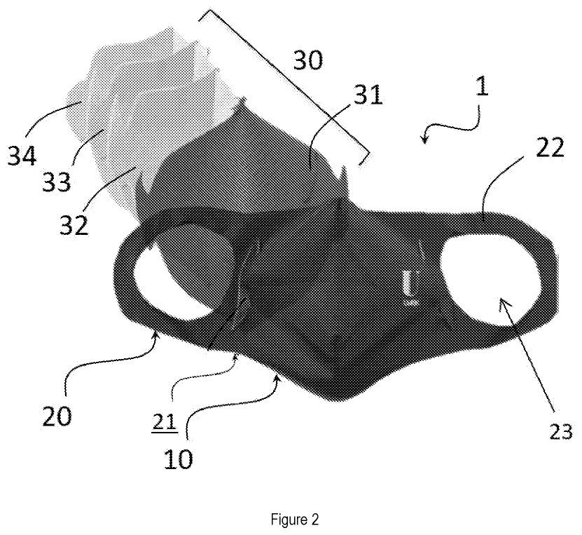

With further reference to FIG. 2, the front portion 10 of the device 1 carries filtering means 30 comprising a bioactive component 32 or 33. Said bioactive component includes usnic acid, and preferably it includes or comprises or, alternatively, consists of usnic acid, or a salt thereof or a complex or compound thereof, or mixtures thereof.

Preferably, the usnic acid, or a salt thereof or a complex or compound thereof, or mixtures thereof of the bioactive component 32 or 33 is extracted from a lichen, preferably a lichen selected from lichens of the genus Usnea, Cladonia, Lecanora, Ramalina, Evemia, Parmelia and Alectoria, more preferably a lichen of the species Usnea barbata.

The usnic acid, or a complex or compound thereof, or an ester thereof, or mixtures thereof, is preferably present in racemic form, or in a form (dextrorotatory or laevorotatory) as a pure enantiomer; preferably, the usnic acid is the compound CAS N. 125-46-2. Preferably, the usnic acid is in the form of a usnic acid sodium salt in an enantiomerically pure dextrorotatory form D(+); preferably said usnic acid and/or a sodium salt thereof present in the Biolayer Liquid Mix is complexed or in association with a cyclodextrin in water: alpha, beta or gamma, preferably β-cyclodextrin, preferably in a 1:1 by weight ratio.

Compositions and/or mixtures comprising usnic acid, or a salt thereof, or a complex or compound thereof, or mixtures thereof, may be provided for. For example, usnic acid, or a salt thereof, or a complex or compound thereof, or mixtures thereof, may be combined with additives suitable to confer selected properties—for example filtering or antiproliferative properties of microorganisms—to the bioactive component.

In advantageous embodiments, the usnic acid, or a salt thereof, or a complex or compound thereof, or mixtures thereof, may be provided in pulverised form and the bioactive component 32 micronized and stabilised on the filtering means 30.

Preferably, the filtering means 30 are removably housed in a chamber 21 inside (preferably comprised between) said retaining means 20. Said chamber is advantageously delimited by, and positioned at, the front portion 10 so that, in the device 1 worn condition, the filtering means 30 directly face the mouth and nose of the user. As mentioned previously, the filtering means 30 can therefore be replaced. In other words, the filtering means 30 are releasably connected to the front portion 10, preferably by means of complementary coupling means (illustrated hereinafter). This allows the filtering means 30 to be easily replaced once they have been used or need to be changed, but without replacing the cover comprising the front portion 10 and the retaining means 20, which can be reused for an indefinite period of time, also considering that it is made of a fabric that can be easily washed and dried without shrinking, still ensuring a complete adhesion to the face of the user.

In the illustrated variant, the front portion 10 comprises at least one opening for access into said chamber 21, in the example, two openings or slots 21a in the form of opposite eyelets (FIG. 4B). Preferably, the filtering means 30 are partially inserted into said at least one opening 21a, preferably in said opposite eyelets.

In the illustrated variant, the front portion 10 comprises at least one opening (or slot) 21a for access into said chamber 21, preferably at least two openings or slots 21a, in the example, two openings or slots 21a in the form of opposite eyelets (FIG. 4B). Therefore, the at least one opening (or slot) 21a passes through the thickness of the front portion 10, from side to side.

Preferably, the filtering means 30 comprise at least one projection or fin 24 releasably inserted into the opening (or slot) 21a. According to such embodiments, the complementary coupling means comprise the at least one opening (or slot) 21a and the at least one projection 24.

The projections 24 are preferably equal in number with respect to the openings (or slots) 21a.

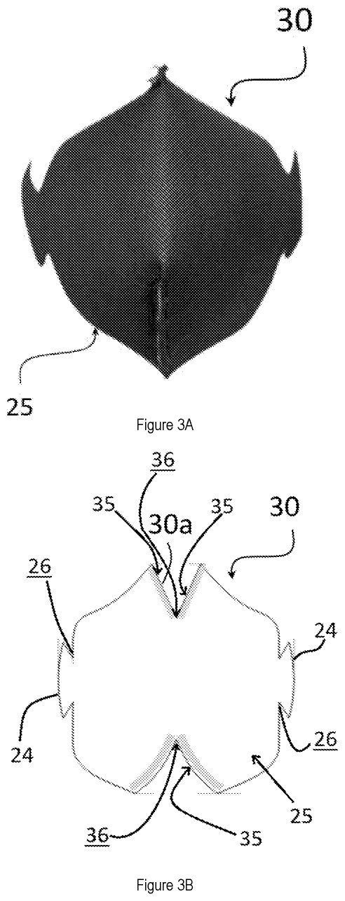

More preferably, the filtering means 30 comprise a filtering body 25 from which said projection 24 protrudes. According to the embodiment of FIG. 3B, a pair of projections 24 extends from opposite sides of the filtering body 25.

Each projection 24 preferably delimits at least one undercut 26 partly accommodating the front portion 10. In this manner, when the filtering means are arranged in said chamber 21, the projection 24 passes through the opening (or slot) 21a, from the inside to the outside, and locks said means to the front portion 10 due to the retaining force exerted by the undercut 26 on the edges of said opening (or slot) 21a.

In this manner, the filtering means 30 may be easily inserted into and/or removed from the device 1.

The chamber 21 may be obtained in the form of a pocket which retains the filtering means 30 therein. Such embodiment has a particular advantage in the case where the front portion 10 and/or the retaining means 20 are made of elastically deformable material. For example, the word “cover” is used to indicate the front portion 10 and the retaining means 20 which may be made as a single piece with a single elastically deformable material.

The front portion 10 and/or the retaining means 20 may be obtained starting from a single sheet or layer of suitably shaped material, preferably from a layer of fabric (for example a single layer of fabric) or from a plurality of superimposed layers of fabric. In particular, as observable in FIG. 4B, one or more shaped sections, indicated in their entirety with reference numeral 13, may be provided for so as to allow a safe adhesion to the facial features, for example at the nasal saddle and/or chin.

More precisely, FIG. 4B illustrates a two-dimensional (stretched) configuration of the front portion 10. The front portion 10 comprises at least two first margins 27, converging with respect to each other and extending toward the internal of the front portion 10 so as to delimit a first recess 28.

When manufacturing the front portion, the first margins 27 are joined together (for example welded, glued or sewn), so as to eliminate a space of the first recess 28, so that the front portion 10 takes a three-dimensional configuration (FIG. 4A).

In the shown embodiments, the front portion 10 comprises at least two pairs of first mutually opposite margins 27, so as to delimit two first recesses 28, that is to say a first upper recess and a first lower recess (according to the orientation of the figures).

Preferably, at least one layer of fabric is at least partially elasticised.

Preferably, at least one layer of fabric is at least partially made of synthetic yarns, more preferably polyamide yarns, even more preferably nylon yarns. Said synthetic yarns are preferably regenerated yarns or obtained from secondary raw materials.

(Information on the CO treatment, which makes the fabric splash resistant, can be found at https://www.mitispa.com/dwr/).

The front portion 10 (FIG. 1) may therefore comprise one or more reinforced sections of the sealing edge 11, 12, for example through processes for welding adjacent flaps using ultrasonic techniques, so as to confer the correct fit features for the device 1 and to ensure the necessary durability in case of extended

The front portion 10 and the relative retaining means 20 are potentially suitable for use for an almost unlimited number of times and they are preferably made of fabric, even more preferably based on 100% sustainable yarns and yarns coming from plastic waste.

Back to FIG. 2 and with further reference to FIGS. 3A and 3B, the aforementioned filtering means 30 preferably comprise a plurality of layers 31, 32, 33, 34—or layers—sealed or joined together along the respective perimeter edges.

Preferably, one or more of said layers 31, 32, 33, 34 (more preferably: all the layers) are subjected to a treatment which confers an electrostatic charge to one or more of said layers.

The electrostatic charge is preferably induced in one or more layers 31, 32, 33, 34 by means of electric discharges, preferably of a positive charge comprised from 2 kw/m² to 20 kw/m², preferably comprised from 4 kw/m² to 15 kw/m², even more preferably comprised from 7 kw/m² to 10 kw/m², for example 8 kw/m².

A layer may be made of a SPUN BP FR 30 gr/m² type of material which is a NWF made of polypropylene (PP) microfibre—Spun material with microfibers therein.

Said layer is subjected to a treatment K carried out by means of electric discharges, visible as small lightnings, with an 8 kw/m² positive charge. Besides increasing the surface tension of the materials, this processing also allows to electrostatically charge the material with an increase in BFE filtration. Since the material is 100% PP, the electrostatic charge increases the surface tension of the material so as to allow a more efficient BFE. Furthermore, all the microbes present in the materials that are passed inside the machine are destroyed. Since the NWF is made of very fine fibres, if suitably packaged, the electrostatic charge remains almost intact even after a long period of time.

The electrostatic charge induced or generated on one or more layers allows to:

(i) increase the surface tension of said layer/s;

(ii) increase the bacterial filtration efficiency (BFE) against bacteria, viruses and other particles, especially when said bacteria, viruses and other particles are negatively charged;

(iii) reduce or eliminate microbial loads initially present in said layer/s;

(iv) preserve the electrostatic charge for a sufficiently long duration (under certain storage conditions), for example for at least 1-6 months. Such storage conditions are preferably guaranteed by a mask casing purposely designed for the present mask.

As a matter of fact, said mask casing houses the wearable face mask 1 partially or substantially fully, to obtain an assembly.

Preferably, the mask casing is made of an antistatic polymeric material, more preferably a polymeric material comprising a number of layers comprised from 2 to 6, more preferably where at least one of said layers comprises or, alternatively, consists of a metallised layer.

More preferably, the mask casing comprises a case delimiting a compartment for housing the wearable face mask 1 and an opening for access to said housing compartment. The access opening may preferably be reversibly closed using a flap for closing said case.

The layers 31, 32, 33, 34 are preferably made of non-woven fabric and the sealing may be obtained as of the ultrasonic type. In any case, this multilayer configuration allows to correctly preserve the bioactive component 32 or 33 inside the filtering means. Experimental tests have shown a lasting effectiveness of the filtering means without the device 1 developing internal proliferation of microorganisms. The layers may be made of polypropylene.

Advantageously, at least one layer 31 of said plurality is made of water-repellent non-woven fabric so as to confer greater filtering effectiveness duration characteristics over time. Said layer is preferably an outer layer of the filtering means (arranged between the layer 32 and the front portion 10).

Preferably, one or more layers of said plurality of layers—except for the bioactive layer of the bioactive component 32 or 33—is characterised by a specific weight comprised from 20 g/m² to 70 g/m², preferably comprised from 25 g/m² to 65 g/m², even more preferably comprised from 27 g/m² to 33 g/m² or from 45 g/m² to 55 g/m². More preferably, one or more layers of said plurality are characterised by the characteristics reported in Table 1 below.

TABLE 1

| Specification | Units | Analysis method | Value |
|---|---|---|---|
| Grammage | [g/m²] | UNI EN 29073-1 | 30 ± 5% |
| Thickness | [mm] | ISO 9073-2 | 0.25-0.36 |
| Permeability | [l/m²/sec] | EN-ISO 9237 | 350-450 |
| | | (200 Pa. 20 cm²) | |
| Fibril diameter | [μm] | | 1-3 |
| Bacteriological filtration | % | EN 14683:2019 | ≥98 |
| efficiency (BFE) | | Annex B | |

Preferably, the first layer 34 comprises the characteristics reported in Table 1 above.

The first layer 34 is preferably designed to come into contact with the face of the user.

In the illustrated example, each layer of said plurality has the same shape and all the layers have reinforced sections 30a, for example at the level of the nasal saddle or chin, and folds suitable to facilitate the wearability and to ensure ergonomics in the device 1 worn condition.

Preferably, with reference to FIG. 3B, the filtering body 25 is initially in a two-dimensional (stretched) configuration. The filtering body 25 comprises at least two second margins 35, converging with respect to each other and extending toward the internal of the filtering body 25 so as delimit a second recess 36.

When manufacturing the filtering means 30, the second margins 35 are joined together (for example welded, glued or sewn), so as to eliminate a space of the second recess 36, so that the filtering body 25 takes a three-dimensional configuration (FIG. 3A).

In the shown embodiments, the filtering body 25 comprises at least two pairs of second mutually opposite margins 35, so as to delimit two second recesses 36, that is to say a second upper recess and a second lower recess (according to the orientation of the figures).

Preferably, the bioactive component 32 or 33, and in particular the usnic acid, or a salt thereof, or a complex or compound thereof, or mixtures thereof, is immobilised in a single bioactive layer, advantageously in an intermediate position between the layers of said plurality. In this manner, the bioactive component 32 or 33 is not directly at direct contact with the face of the user. For example, the bioactive component 32 or 33 may be impregnated in said bioactive layer, through a sequence of submersion, squeezing and drying steps at predetermined temperatures.

Preferably, the bioactive layer of the bioactive component 32 or 33 comprises or, alternatively, consists of polyester, more preferably a polyester non-woven fabric.

More preferably, the bioactive layer of the bioactive component 32 or 33 has the characteristics indicated in Table A below.

TABLE A

| Physical/ | | | | |
|---|---|---|---|---|
| mechanical | | Unit of | | |
| characteristics | Standards | measurement | Values | |
| Weight | ISO 9073.1 | g/m² | 80 ± 10% | |
| Thickness | ISO 9073.2 | mm | 0.7 ± 0.1 | |
| | | | Longitudinal | Transversal |
| | | | (MD) | (CD) |
| Tensile strength | ISO 9073.3 | N/5 cm | ≥150 | ≥200 |
| Elongation | ISO 9073.3 | % | ≥45 | ≥45 |
| at break | | | | |

In the preferred variant illustrated in the figures, the filtering means 30 comprise four superimposed layers joined together to form a single element replaceable by the mask 1. However, the number of layers may vary.

Advantageously, each layer may have different properties. The various layers can be used combined together to obtain a synergistic effect.

For example, a first layer 34 can ensure an exclusively mechanical filtering, for example preventing the inhalation of nanoparticles, that is particles with dimensions comprised between 1 nm and 100 l′(nanometres). In other words, the first layer 34 (at contact with the face of the user) is passed through by a plurality of pores with diameters preferably smaller than 100 nm, more preferably equal to or smaller than 50 nm, even more preferably equal to or smaller than 1 nm, so as to at least partly retain said nanoparticles.

Preferably, the first layer 34 is a closed-cell layer.

Preferably, the first layer 34 at least partly consists of noble fibres.

A second or further layer 33 may be made of (or comprise) electrostatically charged material in order to retain the particles through an electrostatic filtration process.

The present invention has been described so far with reference to preferred embodiments. It is to be understood that there may be other embodiments which are related to the same inventive core, as defined by the scope of protection of the claims reported hereinafter.

Furthermore, forming an object of the present invention are filtering means 30 for a wearable face mask, preferably for the wearable face mask 1 according to any one of the embodiments illustrated above, the filtering means 30 comprising a bioactive component 32 including usnic acid.

Preferably, said bioactive component 32 comprises a usnic acid complex comprising or, alternatively, consisting of usnic acid or a salt thereof, and a cyclodextrin, preferably 3-cyclodextrin.

Preferably, said bioactive component 32 comprises usnic acid or a salt thereof in an enantiomerically pure dextrorotatory form, preferably a usnic acid sodium salt in an enantiomerically pure dextrorotatory form. The filtering means 30 preferably comprise a plurality of layers 31, 32, 33, 34 sealed or joined together along respective perimeter edges, wherein all the layers 31, 32, 33, 34 of said plurality of layers 31, 32, 33, 34 are electrostatically charged.

Preferably, a single layer 32 of said plurality comprises said bioactive component 32.

The filtering means 30 preferably comprise a filtering body 25 comprising at least two second margins 35, converging with respect to each other and extending toward the internal of the filtering body 25 so as to delimit—in a two-dimensional configuration of the filtering body 25—a second recess 36, said second margins 35 being suitable to be joined together—in a three-dimensional configuration—so as to eliminate a space of said second recess 36.

Preferably, said bioactive component 32 is made of non-woven fabric of the spun-bonded type, preferably made of polypropylene, impregnated with usnic acid, or a salt thereof, or a complex or compound thereof, or mixtures thereof.

Furthermore, forming an object of the present invention is an assembly comprising a wearable face mask 1 according to any one of the embodiments illustrated above, and a mask casing accommodating said wearable face mask 1 partially or substantially fully.

### EXPERIMENTAL PART

1) Filtration tests on the bioactive component

The purposes of these tests are the definition and evaluation of the antibacterial properties of the materials subjected to test—both individually and combined together, in order to obtain a face mask having microbial inhibition properties and capable of guaranteeing mechanical performance in relation to the particle filtration efficiency. Lastly, the development of a comparative method in terms of bacterial filtration efficiency, given the particular conformation of the finished product.

All the test activities were conducted with reference to good laboratory practices (GLP) according to the UNI EN ISO CEI/IEQ 17025 technical standard; with regard to the preparation of the growth media PCA (plate count agar) and TSA (tryptone soy agar) were used for microbiological analyses, upon resuspension of the strain used to contaminate the stock solution used to nebulise the surface of the tissue tested with Mycobacterium pneumoniae smegmatis (ATCC 607).

An operative protocol capable of simulating the action of a sneezing in the open environment, thus reproducing—in vitro—the nebulisation effect in vivo was chosen; with the preparation of the solution containing the bacterial strain inserted into a spray nebuliser used for the dispersion of the solution on the surface of the tested material simulating the action of the droplets spread by sneezing. This method allows a to conduct comparative evaluation as provided for by the UNI EN 14683 standard in relation to the shaping of the face mask which does not have a fully flat surface.

2) Ageing test

2.1) Test plan and procurement of specimens The trends of various mechanical and non-mechanical properties, typical of polymers, were evaluated according to the variation of hours of ageing. These included: flexural and tensile elastic modulus, energy absorbed upon impact, coefficient of damping of the material, the density trend and resistance to fire.

The dimensions of the test specimens were chosen in that they are indicated in the Charpy pendulum impact test standards and because it was observed that they can also be suitable for the tensile test, given that they are capable of guaranteeing the minimum length of the section comprised between the two vices, equal to 60 mm. Also with regard to the specimens subjected to resistance to fire, they were mechanised so that the dimensions complied with the standards.

2.1) Accelerated ageing test bench

The ageing of the three types of test specimens was carried out with a test bench set up so as to be as faithful as possible to the standards regulating this particular process.

The accelerated ageing of the components was tested according to the EN ISO 4892-2 standard, in a thermostated chamber at 38° C. and RH=50% for 120′.

3) Bacterial filtration efficiency (BFE) and breathability according to the UNI EN 14683 standard as a function of washing cycles in water.

Analyses were conducted according to the UNI EN 14683 standard. Such analyses showed that the mask subject of the present invention has a 98% filtering capacity and a very good breathability, even after 5 washing cycles in a washing machine at 60° C.

This means that the filtering means can theoretically be reused, with an ensuing environmental benefit and cost-effectiveness in relation to the purchase of new filtering means.

The present mask has a 98% BFE when new, and it remains substantially intact (97%) after the aforementioned 5 washing cycles under the specified conditions.

Breathability has an initial value of 28 Pa/cm² and it deteriorates slightly (30 Pa/cm²) after the aforementioned washing cycles. However, a breathability value below 40 Pa/cm² is considered acceptable according to this standard.

4) Evaluation of the antibacterial activity of the products subjected to antibacterial treatment according to the ISO 22196:2007 standard with respect to Escherichia Coli ATCC 8739 and to Staphylococcus Aureus ATCC 6538P.

The antibacterial activity on the Bio-Layer according to the ISO 20743 standard was measured both at the initial time and after the 200 hours of ageing in a thermostated chamber.

Preferred embodiments E(n) of the present invention are illustrated below:

E1. Face mask (1) that can be worn and configured to filter the air inhaled by a user, the face mask (1) comprising a front portion (10) shaped so as to adhere to the face covering the mouth and nose of the user in the mask-worn condition, retaining means (20) of the front portion (10) to the head of the user, wherein said front portion (10) carries filtering means (30) comprising a bioactive component (32) including usnic acid.

E2. Wearable face mask (1) according to E1, wherein said filtering means (30) are removably housed in a chamber (21) inside said retaining means (20).

E3. Wearable face mask (1) according to E2, wherein said chamber (21) is positioned at said front portion (10).

E4. Wearable face mask (1) according to E1-E3, wherein said filtering means (30) comprise a plurality of layers (31, 32, 33, 34) sealed together along the respective perimeter edges.

E5. Wearable face mask (1) according to E4, wherein a single layer (32) of said plurality comprises said bioactive component.

E6. Wearable face mask (1) according to E4 or E5, wherein a layer (33) of said plurality is electrostatically charged.

E7. Wearable face mask (1) according to any one of E4 to E6, wherein a layer (34) of said plurality is configured to filter nanoparticles.

E8. Wearable face mask (1) according to any one of E4 to E7 comprising an outer layer (31) made of water-repellent non-woven fabric.

E9. Wearable face mask (1) according to any one of E1-E8, wherein said retaining means (20) protrude on opposite sides of said front portion (10) and comprise flaps (21) shaped so as to be constrained to the ears of the user.

E10. Wearable face mask (1) according to any one of E1-E9, wherein said front portion (10) and/or said retaining means (10) are made of elastically deformable breathable fabric.

E11. Filtering cartridge (30) for a wearable face mask (1), the cartridge comprising a support element (32) containing usnic acid.

E12. Filtering cartridge (30) according to E1l, wherein said support element (32) is made of non-woven fabric, preferably polypropylene.

E13. Use of usnic acid in an air filtering system.

E14. Filtering device for the treatment of air comprising a support element containing usnic acid.

Further preferred embodiments F(n) of the present invention are illustrated below:

F1. A face mask (1) that can be worn and configured to filter the air inhaled by a user, the face mask (1) comprising a front portion (10) shaped so as to adhere to the face covering the mouth and nose of the user in the mask-worn condition, retaining means (20) of the front portion (10) to the head of the user and filtering means (30) comprising a bioactive component (32) including usnic acid;

wherein said front portion (10) carries said filtering means (30), and wherein the front portion (10) and the retaining means (20) are obtained starting from a single sheet or layer made of suitably shaped material.

F2. The wearable face mask (1) according to F1, wherein said front portion (10) and said retaining means (10) are made of elastically deformable breathable fabric.

F3. The wearable face mask (1) according to any one of F1-F2, wherein said filtering means (30) are removably housed in a chamber (21) inside said retaining means (20), said chamber (21) being positioned at said front portion (10), and wherein the front portion (10) comprises at least one opening (21a), preferably two opposite eyelets, for access into said chamber (21), the filtering means (30) being partially inserted into said opening (21a).

F4. The wearable face mask (1) according to any one of F1-F3, wherein the filtering means (30) are releasably connected to the front portion (10) by means of complementary coupling means, wherein said complementary coupling means comprise at least one opening (21a) passing through, from side to side, a thickness of the front portion (10) and at least one projection (24) protruding from a filtering body (25) of the filtering means (30), wherein preferably each projection (24) delimits at least one undercut (26) partly housing the front portion (10).

F5. The wearable face mask (1) according to any one of F1-F4, wherein said filtering means (30) comprise a plurality of layers (31, 32, 33, 34) sealed or joined together along the respective perimeter edges, wherein a single layer (32) of said plurality comprises said bioactive component (32).

F6. The wearable face mask (1) according to F5, wherein all layers (31, 32, 33, 34) of said plurality of layers (31, 32, 33, 34) are electrostatically charged.

F7. The wearable face mask (1) according to any one of F1-F6, wherein said retaining means (20) protrude from opposite sides of said front portion (10) and comprise flaps (21) shaped so as to be constrained to the ears of the user, said flaps (22) being closed in a ring with the front portion (10) so as to circumscribe a pair of eyelets (23).

F8. The wearable face mask (1) according to any one of F1-F7, characterised in that it is a duckbill mask.

F9. The wearable face mask (1) according to any one of F1-F8, characterised in that it has a bacterial filtration efficiency according to the UNI EN 14683:2019 standard.

F10. Filtering means (30) for the wearable face mask (1) according to any one of F1-F9, the filtering means (30) comprising a bioactive component (32) including usnic acid.

F11. Filtering means (30) according to F10, wherein said bioactive component (32) comprises a usnic acid complex comprising or, alternatively, consisting of usnic acid or a salt thereof, and a cyclodextrin, preferably a β-cyclodextrin.

F12. Filtering means (30) according to F10 or F11, wherein said bioactive component (32) comprises usnic acid or a salt thereof in an enantiomerically pure dextrorotatory form, preferably a usnic acid sodium salt in an enantiomerically pure dextrorotatory form.

F13. Filtering means (30) according to any one of F10-F12, comprising a plurality of layers (31, 32, 33, 34) sealed or joined together along respective perimeter edges, wherein all the layers (31, 32, 33, 34) of said plurality of layers (31, 32, 33, 34) are electrostatically charged.

F14. Filtering means (30) according to any one of F10-F13, wherein the single layer (32) of said plurality comprises said bioactive component (32).

F15. Filtering means (30) according to any one of F10-F14, comprising a filtering body (25) comprising at least two second margins (35), converging with respect to each other and extending toward the internal of the filtering body (25) so as to delimit—in a two-dimensional configuration of the filtering body (25)—a second recess (36), said second margins (35) being suitable to be joined together—in a three-dimensional configuration—so as to eliminate a space of said second recess (36).

F16. Filtering means (30) according to any one of F10-F15, wherein said bioactive component (32) is made of non-woven fabric of the spun-bonded type, preferably made of polypropylene, impregnated with usnic acid, or a salt thereof, or a complex or compound thereof, or mixtures thereof.

F17. An assembly comprising:
a wearable face mask (1) according to any one of F1-F9;
a mask casing housing said wearable face mask (1) partially or substantially fully.

F18. Filtering means (30) for a wearable face mask (1) comprising a bioactive component (32) and a plurality of layers (31, 32, 33, 34) sealed or joined together along respective perimeter edges; wherein all layers (31, 32, 33, 34) of said plurality of layers (31, 32, 33, 34) are electrostatically charged.

F19. Filtering means (30) according to F18, wherein said layers (31, 32, 33, 34) are electrostatically charged with a positive-sign charge.

F20. Filtering means (30) according to any one of F18-F19, wherein said bioactive component (32) is a single layer (32) of said plurality of layers (31, 32, 33, 34).

F21. Filtering means (30) according to any one of F18-F20, wherein said bioactive component (32) includes, or comprises, or alternatively consists of usnic acid, or a salt thereof, or a complex or compound thereof, or mixtures thereof.

F22. Filtering means (30) according to any one of F18-F21, wherein said bioactive component (32) comprises a usnic acid complex comprising or, alternatively, consisting of usnic acid or a salt thereof, and a cyclodextrin, preferably a β-cyclodextrin.

F23. Filtering means (30) according to claim F21 or F22, wherein said bioactive component (32) comprises usnic acid or a salt thereof in an enantiomerically pure dextrorotatory form.

F24. Filtering means (30) according to F23, wherein said bioactive component (32) comprises a usnic acid sodium salt in an enantiomerically pure dextrorotatory form.

F25. Filtering means (30) according to any one of F18-F24, wherein said bioactive component (32) is made of non-woven fabric of the spun-bonded type, preferably made of polypropylene, impregnated with usnic acid, or a salt thereof, or a complex or compound thereof, or mixtures thereof.

F26. A wearable face mask (1) comprising the filtering means (30) according to any one of F18-F25.

F27. A wearable face mask (1) according to F26, wherein the filtering means (30) are connected to a front portion (10) of said wearable face mask (1) by means of complementary coupling means of the mechanical type, wherein said front portion (10) is shaped so as to adhere to the face covering the mouth and nose of a user in the mask-worn condition.

F28. A wearable face mask (1) and configured to filter the air inhaled by a user, the face mask (1) comprising a front portion (10) shaped so as to adhere to the face covering the mouth and nose of the user in the mask-worn condition, retaining means (20) of the front portion (10) to the head of the user and filtering means (30);

wherein the filtering means (30) are arranged in a chamber (21) partly delimited by said front portion (10) and they are releasably connected to the front portion (10) by means of complementary coupling means of the geometric type.

F29. The wearable face mask (1) according to F28, wherein said complementary coupling means comprise at least one opening (21a), preferably two opposite eyelets, passing through—from side to side—a thickness of the front portion (10), and at least one projection (24) protruding from a filtering body (25) of the filtering means (30).

F30. The wearable face mask (1) according to F29, wherein each projection (24) delimits at least one undercut (26) partly housing the front portion (10).

F31. The wearable face mask (1) according to any one of F28-F30, wherein the front portion (10) and the retaining means (20) are made starting from a single sheet or layer made of suitably shaped material, preferably, wherein said front portion (10) and said retaining means (10) are made of elastically deformable breathable fabric.

F32. The wearable face mask (1) according to any one of F28-F31, wherein said filtering means (30) comprise a plurality of layers (31, 32, 33, 34) sealed or joined together along respective perimeter edges, wherein all the layers (31, 32, 33, 34) of said plurality of layers (31, 32, 33, 34) are electrostatically charged.

F33. The wearable face mask (1) according to any one of F28-F32, wherein said retaining means (20) protrude from opposite sides of said front portion (10) and comprise flaps (21) shaped so as to be constrained to the ears of the user, said flaps (22) being closed in a ring with the front portion (10) so as to circumscribe a pair of eyelets (23).

F34. The wearable face mask (1) according to any one of F28-F33, wherein the filtering means (30) comprise a bioactive component (32) including, or comprising, or alternatively consisting of usnic acid, or a salt thereof, or a complex or compound thereof, or mixtures thereof.

F35. The wearable face mask (1) according to any one of F28-F34, characterised in that it is a flexible duckbill mask.

F36. The wearable face mask (1) according to any one of F28-F35, characterised in that it has a bacterial filtration efficiency according to the UNI EN 14683:2019 standard.

F37. The wearable face mask (1) according to F36, characterised in that it has a bacterial filtration efficiency according to the UNI EN 14683:2019 standard in both directions of through-flow of said mask (1).

F38. Use of usnic acid, or a salt thereof, or a complex or compound, or mixtures thereof, in air filtering means (30), characterised in that said usnic acid and/or a salt thereof is present as D(+) enantiomer, preferably of natural origin; or it is present as a complex or compound combined with a cyclodextrin, preferably β-cyclodextrin, more preferably in a 1:1 by weight ratio.

### LIST OF REFERENCE NUMBERS

1 mask or device
10 front portion
11 sealing edge
12 sealing edge
13 shaped section
20 retaining means
21 chamber
21a opening or slot, preferably eyelet
22 flap
23 eyelet
24 projection or fin
25 filtering body
26 undercut
27 first edge
28 first recess
30 filtering means
30a reinforced section
31 layer
32 bioactive component or third layer
33 second layer or bioactive component
34 first layer
35 second margin
36 second recess

1. A face mask (1) that can be worn and configured to filter the air inhaled by a user, the face mask (1) comprising a front portion (10) shaped so as to adhere to the face covering the mouth and nose of the user in the mask-worn condition, retaining means (20) of the front portion (10) to the head of the user, and filtering means (30) comprising a bioactive component (32) including usnic acid;
wherein said front portion (10) carries said filtering means (30), and wherein the front portion (10) and the retaining means (20) are obtained starting from a single sheet or layer made of suitably shaped material.

2. The wearable face mask (1) according to claim 1, wherein said front portion (10) and said retaining means (10) are made of elastically deformable breathable fabric.

3. The wearable face mask (1) according to claim 1, wherein said filtering means (30) are removably housed in a chamber (21) inside said retaining means (20), said chamber (21) being positioned at said front portion (10), and wherein the front portion (10) comprises at least one opening (21a), preferably two opposite eyelets, for access into said chamber (21), the filtering means (30) being partially inserted into said opening (21a).

4. The wearable face mask (1) according to claim 1, wherein the filtering means (30) are releasably connected to the front portion (10) by means of complementary coupling means, wherein said complementary coupling means comprise at least one opening (21a) passing through, from side to side, a thickness of the front portion (10) and at least one projection (24) protruding from a filtering body (25) of the filtering means (30), wherein preferably each projection (24) delimits at least one undercut (26) partly housing the front portion (10).

5. The wearable face mask (1) according to claim 1, wherein said filtering means (30) comprise a plurality of layers (31, 32, 33, 34) sealed or joined together along the respective perimeter edges, wherein a single layer (32) of said plurality comprises said bioactive component (32).

6. The wearable face mask (1) according to claim 5, wherein all layers (31, 32, 33, 34) of said plurality of layers (31, 32, 33, 34) are electrostatically charged.

7. The wearable face mask (1) according to claim 1, wherein said retaining means (20) protrude from opposite sides of said front portion (10) and comprise flaps (21) shaped so as to be constrained to the ears of the user, said flaps (22) being closed in a ring with the front portion (10) so as to circumscribe a pair of eyelets (23).

8. The wearable face mask (1) according to claim 1, characterised in that it is a duckbill mask.

9. The wearable face mask (1) according to claim 1, characterised in that it has a bacterial filtration efficiency according to the UNI EN 14683:2019 standard.

10. Filtering means (30) for the wearable face mask (1) according to claim 1, the filtering means (30) comprising a bioactive component (32) including usnic acid.

11. Filtering means (30) according to claim 10, wherein said bioactive component (32) comprises a usnic acid complex comprising or, alternatively, consisting of usnic acid or a salt thereof, and a cyclodextrin, preferably a β-cyclodextrin.

12. Filtering means (30) according to claim 10, wherein said bioactive component (32) comprises usnic acid or a salt thereof in an enantiomerically pure dextrorotatory form, preferably a usnic acid sodium salt in an enantiomerically pure dextrorotatory form.

13. Filtering means (30) according to claim 10, comprising a plurality of layers (31, 32, 33, 34) sealed or joined together along respective perimeter edges, wherein all the layers (31, 32, 33, 34) of said plurality of layers (31, 32, 33, 34) are electrostatically charged.

14. Filtering means (30) according to claim 10, wherein the single layer (32) of said plurality comprises said bioactive component (32).

15. Filtering means (30) according to claim 10, comprising a filtering body (25) comprising at least two second margins (35), converging with respect to each other and extending toward the internal of the filtering body (25) so as to delimit—in a two-dimensional configuration of the filtering body (25)—a second recess (36), said second margins (35) being suitable to be joined together—in a three-dimensional configuration—so as to eliminate a space of said second recess (36).

16. Filtering means (30) according to claim 10, wherein said bioactive component (32) is made of non-woven fabric of the spun-bonded type, preferably made of polypropylene, impregnated with usnic acid, or a salt thereof, or a complex or compound thereof, or mixtures thereof.

17. An assembly comprising:
a wearable face mask (1) according to claim 1;
a mask casing housing said wearable face mask (1) partially or substantially completely.

18. Filtering means (30) of a wearable face mask (1) comprising a bioactive component (32) and a plurality of layers (31, 32, 33, 34) sealed or joined together along respective perimeter edges;
wherein all layers (31, 32, 33, 34) of said plurality of layers (31, 32, 33, 34) are electrostatically charged.

19-25. (canceled)

26. A wearable face mask (1) comprising the filtering means (30) according to claim 1.

27. A wearable face mask (1) according to claim 26, wherein the filtering means (30) are connected to a front portion (10) of said wearable face mask (1) by means of complementary coupling means of the mechanical type, wherein said front portion (10) is shaped so as to adhere to the face covering the mouth and nose of a user in the mask-worn condition.

28-38. (canceled)
